(19) United States
(12) Patent Application Publication
(10) Pub. No.: US 2017/0264631 A1
(43) Pub. Date: Sep. 14, 2017

(54) CONTROL DEVICE FOR A NETWORK AND VULNERABILITY SCANNER

(71) Applicant: DEUTSCHE TELEKOM AG, Bonn (DE)

(72) Inventors: Markus EGGERT, Hennef (DE); Patrick MEIER, Bonn (DE); Daniel HAUENSTEIN, Bonn (DE)

(21) Appl. No.: 15/500,123

(22) PCT Filed: Aug. 11, 2015
(86) PCT No.: PCT/EP2015/068427

§ 371 Date: Jan. 30, 2017

(30) Foreign Application Priority Data
Aug. 14, 2014 (EP) 14180914.5

(51) Int. Cl. H04L 29/06

(52) U.S. Cl. CPC H04L 63/1433; H04L 63/08; H04L 63/0428

(57) ABSTRACT

A control device for a network and vulnerability scanner for testing a computer system for the presence of security vulnerabilities includes: a first interface for selecting a test profile which comprises parameter data that define a test of the computer system, wherein the parameter data include a user's administrative login data for the computer system; and a second interface for transmitting the parameter data of the test profile to the network and vulnerability scanner.

### CROSS-REFERENCE TO RELATED APPLICATIONS

This application is a U.S. National Phase application under 35 U.S.C. §371 of International Application No. PCT/EP2015/068427, filed on Aug. 11, 2015, and claims benefit to European Patent Application No. EP 14180914.5, filed on Aug. 14, 2014. The International Application was published in German on Feb. 18, 2016 as WO 2016/023890 A1 under PCT Article 21(2).

### FIELD

The present invention relates to a control device for a network and vulnerability scanner for testing a computer system for the presence of security vulnerabilities.

### BACKGROUND

In network and vulnerability scanners for testing a computer system for the presence of security vulnerabilities, carrying out a test initially requires manual adjustment of numerous parameters by a user. The use of the network and vulnerability scanner is therefore associated with high levels of administration and maintenance. The administrative burden includes for example creating users who are permitted to use the network and vulnerability scanner or entering permissions for users in the event that only a limited range of functions is supposed to be accessed. In order to carry out the test, additional parameters are entered, for example creating an asset before a test is carried out so that the target system is persistently recorded in a database. In addition, when the target system is recorded, a plurality of additional parameters are passed, for example passwords or other login information for the target system.

Existing network and vulnerability scanners often do not give an option of defining specific dependencies when a test may actually intended to be carried out. For example, there is no option of preventing a test from being carried out when incorrect login data have been passed for the target system. In this case, the tests can be carried out according to a best effort approach.

The tests are often carried out only in the late development stages of a project, meaning that troubleshooting takes place shortly before completion of the project and delays a release. The carrying out of the tests is performed by security specialists and requires coordination of functional tests and security tests.

### SUMMARY

In an exemplary embodiment, the present invention provides a control device for a network and vulnerability scanner for testing a computer system for the presence of security vulnerabilities. The control device includes: a first interface for selecting a test profile which comprises parameter data that define a test of the computer system, wherein the parameter data include a user's administrative login data for the computer system; and a second interface for transmitting the parameter data of the test profile to the network and vulnerability scanner.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view of a computer system;

FIG. 2 is a view of a user authentication in a control device;

FIG. 3 is a view of an entry of parameter data;

FIG. 4 is another view of an entry of parameter data; and

FIG. 5 is a view of a test result.

### DETAILED DESCRIPTION

Exemplary embodiments of the invention simplify a test of a computer system for the presence of security vulnerabilities.

According to a first aspect of the invention, a control device for a network and vulnerability scanner for testing a computer system for the presence of security vulnerabilities includes: a first interface for selecting a test profile which comprises parameter data that define a test of the computer system; and a second interface for transmitting the parameter data of the test profile to the network and vulnerability scanner. A technical advantage is thus achieved, for example, in that the parameters are consolidated in a test profile and a complete set of parameters is transmitted to the network and vulnerability scanner. By selecting a test profile, the operation of the network and vulnerability scanner is simplified. The control device can be implemented on a computer. The parameter data include a user's administrative login data for the computer system.

In an advantageous embodiment of the control device, the network and vulnerability scanner can be linked in a modular manner to the first or second interface of the control device. A technical advantage is thus achieved, for example, in that the control device can be coupled to a plurality of different network and vulnerability scanners.

In another advantageous embodiment of the control device, the first or second interface is designed to transmit the parameter data to the network and vulnerability scanner in a cryptographically encrypted manner. A technical advantage is thus achieved, for example, in that unauthorized reading of the parameter data is prevented.

In another advantageous embodiment of the control device, the first or second interface is designed to produce a cryptographically encrypted connection to a user terminal. A technical advantage is thus also achieved, for example, in that unauthorized interception of the connection is prevented.

In another advantageous embodiment of the control device, the control device is designed to authenticate a user. A technical advantage is thus achieved, for example, in that only authorized users can control the network and vulnerability scanner using the control device.

In another advantageous embodiment of the control device, the control device is designed to automatically detect a model of the network and vulnerability scanner at the second interface. A technical advantage is thus achieved, for example, in that different test profiles can be used depending on the network and vulnerability scanner.

In another advantageous embodiment of the control device, the control device is designed to determine the test profile on the basis of the model of the network and vulnerability scanner. A technical advantage is thus achieved, for example, in that the test profiles can be preselected by the control device on the basis of the network and vulnerability scanner.

In another advantageous embodiment of the control device, the control device is designed to determine the test profile on the basis of an operating system of the computer system. A technical advantage is thus achieved, for example, in that the test profiles can be preselected on the basis of the operating system of the target system and different tests can be carried out depending on the operating system.

In another advantageous embodiment of the control device, the control device is designed to determine the test profile on the basis of a logical destination address of the computer system. A technical advantage is thus achieved, for example, in that different tests can be carried out depending on the destination address.

According to a second aspect of the invention, a control method for a network and vulnerability scanner for testing a computer system for the presence of security vulnerabilities includes the steps of: selecting a test profile on a control device, which profile comprises parameter data that define a test of the computer system; and transmitting the parameter data of the test profile from the control device to the network and vulnerability scanner. A technical advantage is thus also achieved, for example, in that the operation of the network and vulnerability scanner is simplified. The parameter data include a user's administrative login data for the computer system.

In an advantageous embodiment of the method, the method includes the step of cryptographically encrypting the parameter data. A technical advantage is thus also achieved, for example, in that unauthorized reading of the parameter data is prevented.

In another advantageous embodiment of the method, the method includes the step of authenticating a user on the control device. A technical advantage is thus also achieved, for example, in that unauthorized use is prevented.

In another advantageous embodiment of the method, the method includes the step of automatically detecting the model of the network and vulnerability scanner on the control device. A technical advantage is thus achieved, for example, in that the test profiles can be preselected by the control device on the basis of the network and vulnerability scanner.

According to a third aspect of the invention, a computer system includes: a network and vulnerability scanner for testing the computer system for the presence of security vulnerabilities; and a control device for the network and vulnerability scanner, comprising a first interface for selecting a test profile which comprises parameter data that define a test of the computer system; and a second interface for transmitting the parameter data of the test profile to the network and vulnerability scanner. A technical advantage is thus also achieved, for example, in that the operation of the network and vulnerability scanner is simplified.

According to a fourth aspect of the invention, a computer program includes a program code for carrying out the method according to the second aspect if the computer program is executed on a computer. A technical advantage is thus also achieved, for example, in that the operation of the network and vulnerability scanner is simplified.

Embodiments of the invention are shown in the drawings and are described in more detail in the following.

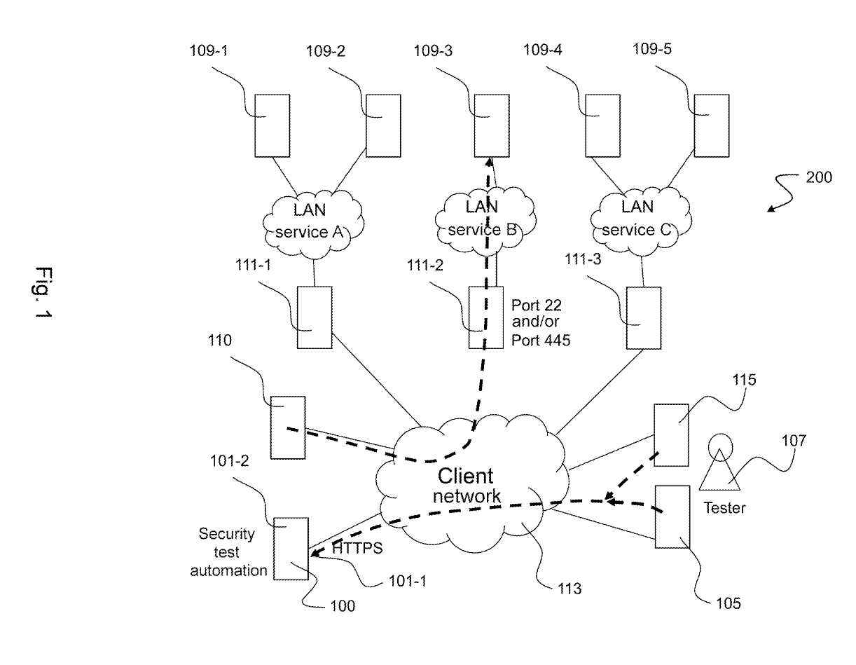

FIG. 1 is a schematic view of a computer system 200. The computer 200 comprises the computers 109-1, . . . , 109-5. The computers 109-1, . . . , 109-5 are connected via firewalls 111-1, . . . , 111-3 and corresponding data lines to a network 113, for example an intranet. A notebook computer 115 or desktop computer 105 and a control device 100 are also connected to the network 113. The computers 109-1, . . . , 109-5 can be reached via port 22 and/or 445. The control device 100 is used to control a network and vulnerability scanner which checks the computer system 200 for the presence of security vulnerabilities.

A plurality of problems can arise when carrying out the test in the computer system 200. The complexity for a single test is relatively high. A user generally logs in directly to a network and vulnerability scanner, locates a corresponding profile and customizes a host asset. The use of the network and vulnerability scanner and the customization of the test profiles are extensive. In order to correctly operate the network and vulnerability scanner, an extensive understanding of security aspects is required which not every user has.

In addition, there is a high level of administrative burden in carrying out the tests for security vulnerabilities since it is ensured that a user only tests specific target systems. In a security environment in which the test results contain sensitive information, it is not desirable if a user 107 can test any desired computer systems for security vulnerabilities. The control device 100 makes it possible to carry out tests on individual computers 109-1, . . . , 109-5 of the computer system 200, even if the user 107 only has limited experience in using automated network and vulnerability scanners.

The control device 100 makes a simple operation possible even for a user 107 who does not have knowledge in the field of information technology security in that test profiles can be selected which have parameters that define the test of the computer system 200. The control device 100 can be formed by a computer.

The control device 100 comprises a first interface 101-1 for selecting a test profile and a second interface 101-2 for transmitting the parameter data of the selected test profile to one (or more) network and vulnerability scanner(s) 110. The test profile comprises a plurality of predetermined parameter data for carrying out the test, for example login data for the network and vulnerability scanner or port ranges for the test.

The control device 100 is controlled by a user terminal 105 or 115 of the user 107 via the first interface 101-1 and the network 113. The network and vulnerability scanner 110 can be linked to the control device 100 in a modular manner. Overall, the use of the control device 100 results in lower operating expenses for carrying out the test in the computer system 200.

The control device 100 reduces the complexity of network and vulnerability scanners for carrying out tests in the computer system in order to check the computer system 200 for the presence of security vulnerabilities. By using test profiles having a number of preset parameters, the user can test any test system at any time without performing extensive configurations or customizations in the test implementation beforehand. The control device 100 does not itself require tests to be carried out, but rather can be used as a simplified control entity for downstream network and vulnerability scanners 110 which carry out the actual tests.

For example, the control device 100 can trigger vulnerability and compliance tests and return the test results to the user in a consolidated manner. The network and vulnerability scanner can be linked by providing a remote access interface (Remote-API) which enables the network and vulnerability scanner to be controlled via a programmatic interface.

The test profile defines, for example via parameters, which security defects in the target system should be tested. This can take place on the basis of the operating system of the target system in order to carry out downstream operating system-specific tests. For testing, a corresponding asset can be selected which is associated with a corresponding test profile. The test profile can also comprise login data. After testing, the results are provided by the control device 100.

The control device 100 simplifies control in that a large part of the associated effort is abstracted and the user is provided with an interface having test profiles, for example a web portal, which ensures a reduced and simplified procedure for carrying out the testing. Subsequently, a test is carried out via a portal of the control device 100 as the interface.

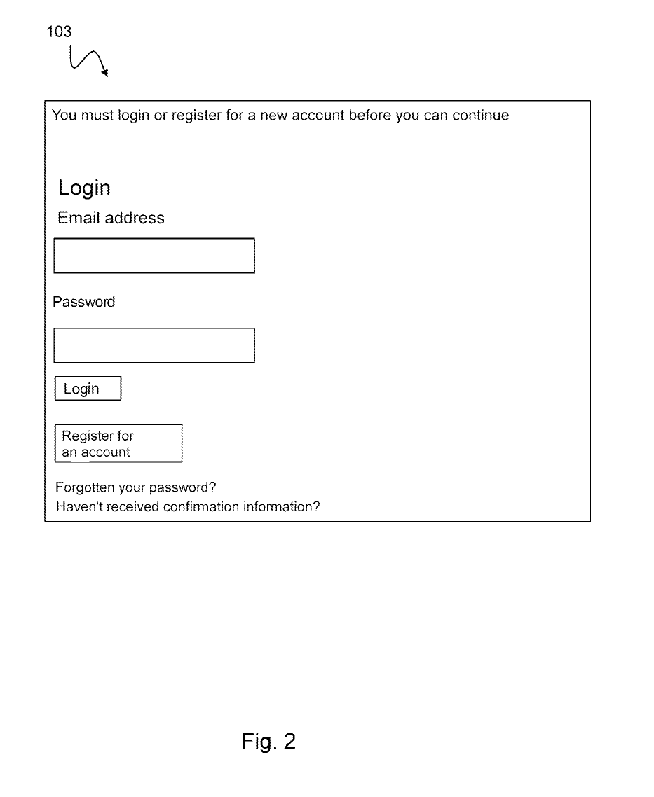

FIG. 2 depicts a view of a user authentication in the control device 100 via a login screen 103. The users 107 can register themselves on the control device 100, for example using an email address which is verified in the registration process. After successful registration, the user can log in to the control device 100 using a password.

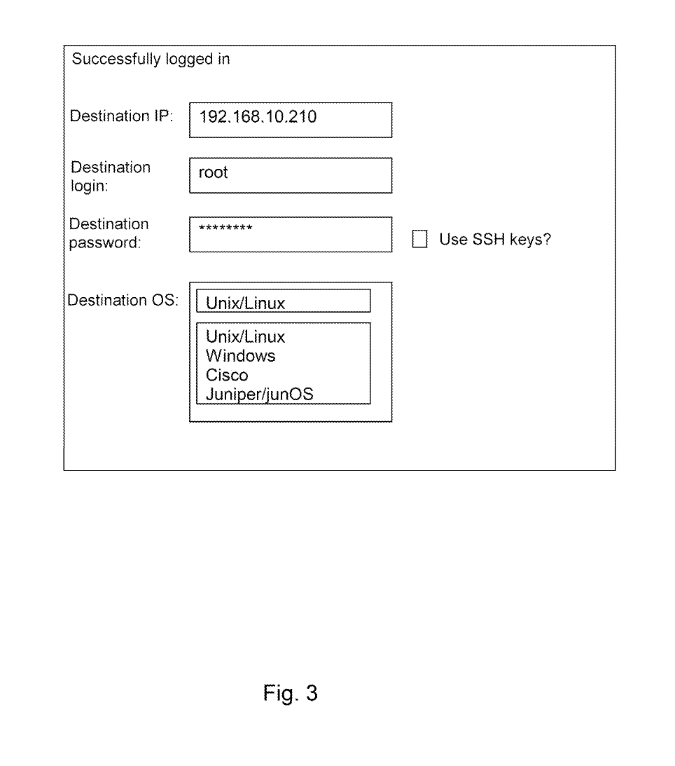

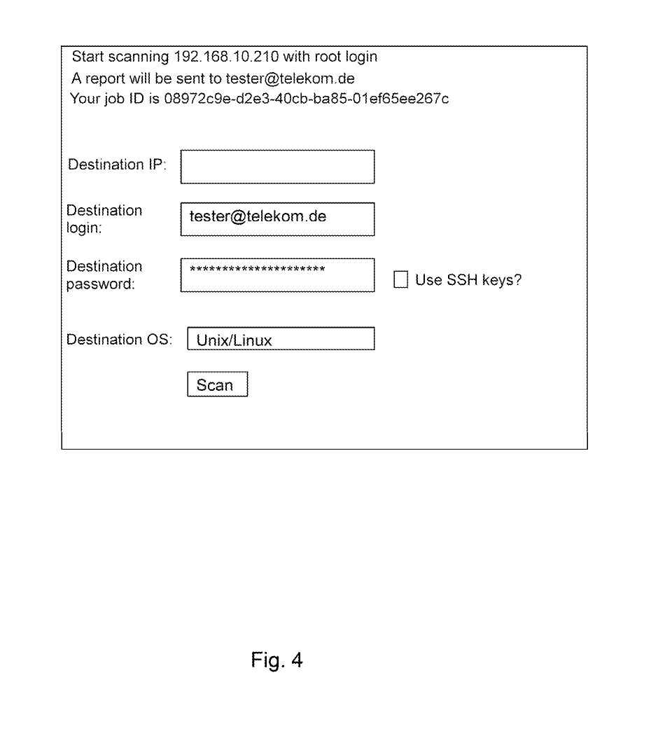

FIG. 3 and FIG. 4 depict views of an entry of parameter data on the control device 100. After login, a limited number of parameters can be passed by the user 107, for example the network address of the target system, administrative login data for the target system, or an operating system of the target system to be tested.

After the data have been passed, some tests are carried out first. First it is ascertained whether the target system can be reached by a network. If it cannot be reached, a test is not initiated. Next it is ascertained that the passed login data for the target system are in fact administrative logins. This eliminates the maintenance of access permissions for the users 107 since it can be assumed that a user 107 who has the administrative access rights to a system also has sufficient permissions in order to test for security vulnerabilities. If the data are not correct, a test is not initiated but instead cancelled. If these tests are successfully completed, the test is started.

In this case, a plurality of steps is carried out. A profile having corresponding parameters is created on the network and vulnerability scanner that is carrying out the test. Login data can be recorded in this profile. The profile can be used for a plurality of test solutions. The test is started by the network and vulnerability scanner.

The result of the test is called up by the control device 100 after the test has been carried out. If desired, downstream tests can be started. For example, the control device 100 can permit vulnerability tests and compliance tests to be started one after the other. After all the results are available, all the profiles and results in the network and vulnerability scanner that were created for the testing are deleted.

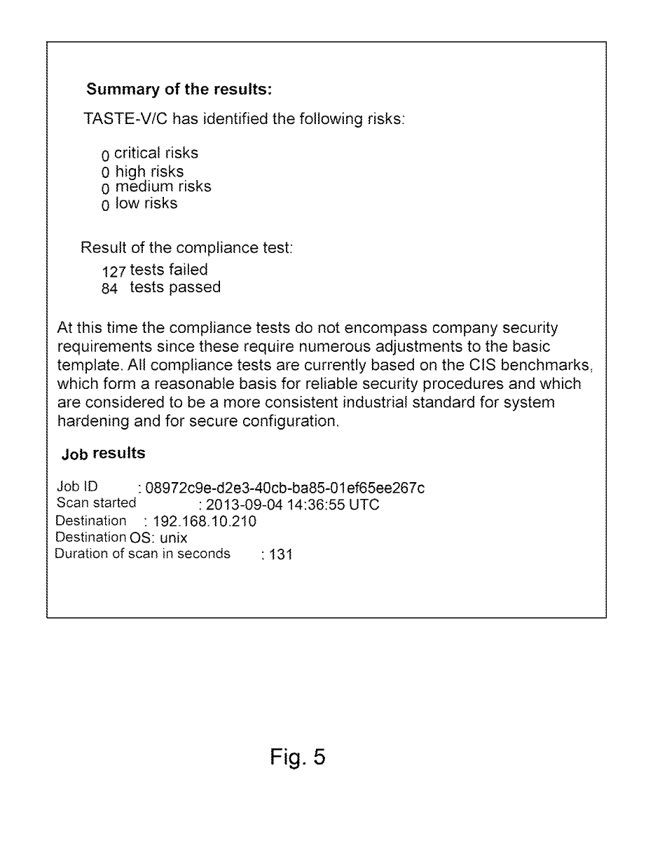

FIG. 5 shows a view of a test result that is provided by the control device 100. The test result can be sent with a short summary to the user 107 by email.

The advantages of the control device 100 are a highly simplified use for technically inexperienced users 107 and a significantly reduced level of maintenance, since neither a user 107 nor permissions must be assigned in the control device 100. Correct parameters for carrying out the test are automatically selected and a plurality of test runs using different network and vulnerability scanners may be carried out one after the other. The logic of the test runs of the test is defined and determined in the control device 100. For example, a compliance test can be carried out after a vulnerability test in that the results for the vulnerability test are used as input parameters. Compliance tests can, for example, depend on the selection of the correct target operating system. This selection can take place automatically after a successful vulnerability test since the operating system has already been determined.

All the features described and disclosed in relation with individual embodiments of the invention can be provided in different combinations in the subject matter according to the invention, in order to achieve the advantageous effects thereof at the same time.

The scope of protection of the present invention is specified by the claims and is not limited by the features described in the description or shown in the drawings.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 control device

101 interface

103 login screen

105 user terminal (stationary, desktop)

107 user

109 computer

110 network and vulnerability scanner

111 firewall

113 network

115 user terminal (mobile, notebook)

200 computer system

1: A control device for a network and vulnerability scanner for testing a computer system for the presence of security vulnerabilities, comprising:
a first interface for selecting a test profile which comprises parameter data that define a test of the computer system, wherein the parameter data include a user's administrative login data for the computer system; and
a second interface for transmitting the parameter data of the test profile to the network and vulnerability scanner.

2: The control device according to claim 1, wherein the network and vulnerability scanner is configured to be linked to the second interface of the control device in a modular manner.

3: The control device according to claim 1, wherein the second interface is configured to transmit the parameter data to the network and vulnerability scanner in a cryptographically encrypted manner.

4: The control device according to claim 1, wherein the first interface is configured to produce a cryptographically encrypted connection to a user terminal.

5: The control device according to claim 1, wherein the control device is configured to authenticate a user.

6: The control device according to claim 1, wherein the control device is configured to automatically detect a model of the network and vulnerability scanner at the second interface.

7: The control device according to claim 6, wherein the control device is configured to determine the test profile based on the model of the network and vulnerability scanner.

8: The control device according to claim 1, wherein the control device is configured to determine the test profile based on an operating system of the computer system.

9: The control device according to claim 1, wherein the control device is configured to determine the test profile based on a logical destination address of the computer system.

10: A control method for a network and vulnerability scanner for testing a computer system (200) for the presence of security vulnerabilities, the method comprising:
selecting a test profile on a control device, wherein the test profile comprises parameter data that define a test of the computer system, wherein the parameter data include a user's administrative login data for the computer system; and
transmitting the parameter data of the test profile from the control device to the network and vulnerability scanner.

11: The method according to claim 10, further comprising:
cryptographically encrypting the parameter data.

12: The method according to claim 10, further comprising:
authenticating a user on the control device.

13: The method according to claim 10, further comprising:
automatically detecting a model of the network and vulnerability scanner on the control device.

14: A computer system, comprising:
a network and vulnerability scanner for testing the computer system for the presence of security vulnerabilities; and
a control device for the network and vulnerability scanner, comprising:
a first interface for selecting a test profile, which comprises parameter data that define a test of the computer system, wherein the parameter data include a user's administrative login data for the computer system; and
a second interface for transmitting the parameter data of the test profile to the network and vulnerability scanner.

15: A non-transitory, computer-readable medium having processor-executable instructions stored thereon for a control method for a network and vulnerability scanner for testing a computer system (200) for the presence of security vulnerabilities, wherein the processor-executable instructions, when executed, facilitate performance of the control method of claim 10.
